(19) United States
(12) Patent Application Publication
(10) Pub. No.: US 2014/0197047 A1
(43) Pub. Date: Jul. 17, 2014

(54) Storage Container for Emergency Fuel

(71) Applicants: Joseph Lawrence Kellogg, Webster, NY (US); Mingming Guo Kellogg, Webster, NY (US)

(72) Inventors: Joseph Lawrence Kellogg, Webster, NY (US); Mingming Guo Kellogg, Webster, NY (US)

(21) Appl. No.: 13/741,438

(22) Filed: Jan. 15, 2013

(51) Int. Cl. F17C 3/00

(52) U.S. Cl. CPC F17C 3/00
USPC 206/6

(57) ABSTRACT

A container constructed for the purpose of containing an emergency reserve quantity of fuel which is hermetically sealed against hydrocarbon vapors and coated with a fire resistant coating which can be opened and emptied into the fuel tank of an automobile.

As long as people have been driving cars (from here on, the term ‘car’ refers to any type of automobile), drivers have been confronted with the issue of what to do when you run out of gas (gasoline or other fuel; from here on, the word ‘gas’ refers to whatever liquid fuel is used to power the automobile referenced). Most people resort to one of two methods to obtain enough gas to get to a filling station: 1. Walk to a gas station and buy a container plus one gallon of gas or 2. Call a tow truck to bring a gallon of gas. The draw backs are that option 1 is very time intensive and option 2 can be both time intensive and expensive. In extreme weather conditions, time isn't just an inconvenience, it is a health hazard. Another alternative that some people use is to fill a plastic container with gas and store it in their vehicle just in case. Unfortunately, this is dangerous for two reasons: 1. Gas evaporates directly through most plastics and, given the right conditions, this can allow vapors to build up to explosive levels and 2. If the car were to catch fire, the plastic would soon burn, releasing dangerous fuel vapors, thereby worsening the situation. The authors propose a new type of container which addresses these concerns, making it possible to safely carry an emergency reserve of gas in the car.

### PRIOR ART

Through the years, a few people have developed methods of storing a reserve fuel source within the car. Most notably are the inventions by Spencer, et al. which describe a container with a pull-out spout which is intended for one single use. Equally important is the invention by Hubbard, et al. which describes a sealed container with a spout built into the container for easy filling. While these inventors did a very good job of creating a container that was spill resistant and would be able to fit in small areas of a car. However, there are two deficiencies with these inventions. First off, it is commonly known that gas is a highly flammable liquid and, should the car catch fire, a container of gas is prone to worsening the fire, especially when the container is plastic—a burnable material. Secondly, gas is able to permeate plastic, even when the opening has been sealed. This can lead to a build-up of fumes within the car which poses certain health and fire hazards.

To prevent the permeation of gas (and other products) through plastic, companies such as Flouro-Seal International, L.P. have been treating plastics with fluorine in order to inhibit transfer. This has been limited to built-in gas tanks and product containers for other volatile substances. Also, Yeh, has invented a way to build a container with a reduced permeability—but the permeation is not as low as achievable through fluorine treatment.

In the oil platform industry, because of the constant presence of large volumes of petroleum, intumescent, fire retardant coatings—such as the one invented by Reinheimer are used for protection. Sinclair, et al. applied this idea to fire protection for steel framed buildings that are found in large cities. Autovino et al. invented the use of an intumescent coating on fire doors—allowing protection beyond 90 minutes. Cornwall realized the value of adding an intumescent coating to plastic components. To the best of the authors' knowledge, no one has created a container for storing an emergency reserve of gas which has been treated with fluorine to prevent permeation and applied a fire retardant coating to an emergency fuel container.

### DESCRIPTION OF THE INVENTION

The present invention builds on the works of the previous inventors by making use of a plastic container (1) with a single use, removable seal (2). The container can be either built with a pour spout built into the container (FIG. 3) or in the form of an adaptive cap (FIGS. 1 & 2) which is installed at the time of use.

The basis of the present invention is the application of two long standing processes to make a container safe for storing a reserve quantity of gas for emergency use. Intumescent coatings are used on everything from construction girders to oil platforms to marine fuel tanks. The coating works by melting and creating a thick, viscous layer which insulates the interior from the effects of the fire. Depending on the type of coating and the thickness of the coating, this can extend the fire resistance rating of an object to 90 minutes and beyond.

The present invention is a new application of this long standing process by applying a coating to a plastic container in order to make it safe to store a quantity of gas for emergency use. By applying the intumescent coating, we are solving the problem of what were to happen if there was a car fire and a container of gas was stored in the car. The intumescent coating allows the occupants of the car additional time in which to exit the car in the event of a disaster.

The present invention uses fluorine treatments to reduce the permeability of the plastic container in order to keep the light compounds from diffusing through the plastic container. This prevents two things from occurring: the gas becoming impotent and a build-up of flammable gasses within the car.

To the best knowledge of the inventors, no one has created a container for storing a reserve quantity of gas for emergency use which has been made safe through the use of intumescent coatings and fluorine treatments. Previous inventors have used said treatments to make built in plastic fuel tanks safe, however, these are meant for holding a primary fuel source rather than an emergency reserve and are built into the vehicle rather than a separate container stored in the car.

### DESCRIPTION OF FIGURES

FIGS. 1 and 2 are two different figures demonstrating one possible embodiment of the storage container for emergency fuel. Item 1 is the plastic container which has received a surface modification with fluorine and a fire retardant coating. Item #2 is a foil induction seal which is used to seal the mouth of the container, preventing the gas from evaporating. Item #3 is a cap which is only removed at time of use. Item #4 is a separate nozzle which may be attached at time of use to ensure that all of the fuel is emptied into the gas tank.

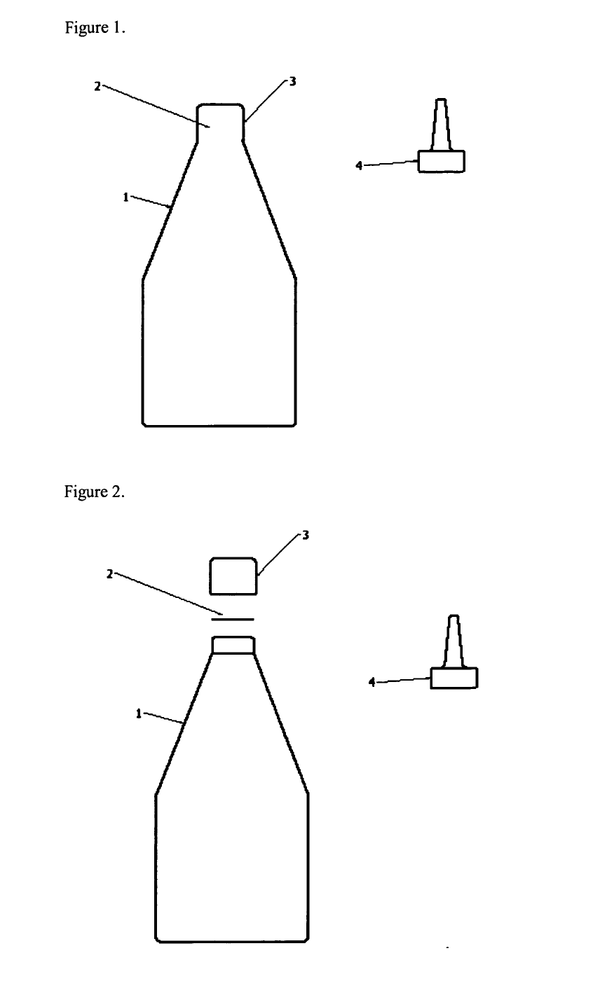

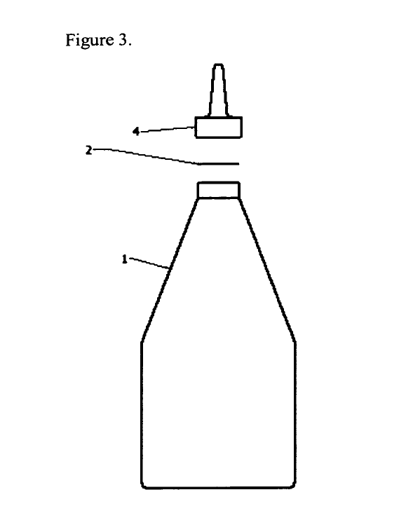

FIG. #3 shows a second possible embodiment of the invention. Here, item #1 is the plastic container and item #2 is the foil seal as in FIGS. 1 & 2. With this embodiment, the nozzle (item #4) is the primary closure for the container.

1. A plastic container of appropriate size to carry sufficient gas to re-start a car and drive several miles or more and shaped in such a way that the gas may be dumped directly into the gas tank on the car or have an adaptive cap provided to allow the gas to be emptied directly into the gas tank of the car and able to be sealed with a single use seal.

2. Said plastic container is treated with fluorine to make it impervious to gas vapors.

3. Said plastic container has been treated with a flame resistant coating.
